(19) United States
(12) Patent Application Publication
(10) Pub. No.: US 2026/0218057 A1
(43) Pub. Date: Jul. 30, 2026

(54) METHOD OF PRODUCING METALLURGICAL COKE AND METHOD OF EVALUATING THERMOPLASTICITY

(71) Applicants: JFE STEEL CORPORATION, Chiyoda-ku, Tokyo (JP); NIPPON PAPER INDUSTRIES CO., LTD., Kita-ku, Tokyo (JP)

(72) Inventors: Takanori TAKASHIMA, Chiyoda-ku, Tokyo (JP); Ken KAWAUCHI, Chiyoda-ku, Tokyo (JP); Takashi MATSUI, Chiyoda-ku, Tokyo (JP); Takuto SHAKUNO, Kita-ku, Tokyo (JP); Yutaka NURUKI, Kita-ku, Tokyo (JP); Shoichi MIYAWAKI, Kita-ku, Tokyo (JP)

(73) Assignees: JFE STEEL CORPORATION, Chiyoda-ku, Tokyo (JP); NIPPON PAPER INDUSTRIES CO., LTD., Kita-ku, Tokyo (JP)

(21) Appl. No.: 19/147,051

(22) PCT Filed: Feb. 22, 2024
(86) PCT No.: PCT/JP2024/006648

§ 371 Date: Jul. 10, 2025

(30) Foreign Application Priority Data
Mar. 1, 2023 (JP) 2023-031433

(51) Int. Cl. C10B 57/06; G01N 11/04

(52) U.S. Cl. CPC C10B 57/06; G01N 11/04

(57) ABSTRACT

To produce coke strong enough to withstand blast furnace use while using a larger amount of biomass as a coke raw material compared to conventional techniques, a method is provided of producing metallurgical coke by dry distillation of raw material in a chamber-type coke oven to produce metallurgical coke. The raw material contains, at 30 wt % or less relative to the raw material total, isolated lignin that satisfies specific conditions.

### TECHNICAL FIELD

The present disclosure relates to a method of producing metallurgical coke and a method of evaluating thermoplasticity.

### BACKGROUND

In the production of pig iron using a blast furnace, coke is used to reduce iron ore and secure gas permeability in the blast furnace. Coke used for such purposes is referred to as metallurgical coke (hereinafter, when referring simply to coke, metallurgical coke is being referenced). The coke is typically produced by dry distillation of coal as a raw material in a coke oven.

At least half of the CO₂ generated in a blast furnace is derived from carbon in coke. Therefore, if coal used as a raw material for coke could be replaced by a biomass that is a carbon-neutral material, this would greatly contribute to a decrease in CO₂ emissions from blast furnaces. Therefore, there is demand for a technology that uses biomass raw material instead of coal as a raw material for coke.

However, as reported in Non-Patent Literature (NPL) 1 and 2, when biomass is mixed with coal and charged into a coke oven, the flowability of the coal during dry distillation is greatly decreased, resulting in a decrease in strength of the resulting coke. Therefore, using biomass as a raw material for coke without special pretreatment is difficult. The cause of decreased flowability of coal due to biomass is not entirely clear, but is thought to be due to the relatively high concentration of oxygen atoms in the biomass, which decrease melting properties of the coal during dry distillation.

Therefore, in order to use biomass as a coke raw material without decreasing the strength of the coke, the use of biomass that has a low oxygen content has been considered.

For example, in Patent Literature (PTL) 1 and 2, methods are proposed for producing coke by adding char obtained from pyrolysis of biomass to coal. Further, NPL 2 focuses on the fact that the oxygen content of lignin, one of the main components of woody biomass, is lower than that of other components, and considers the use of lignin extracted from woody biomass as a coke raw material.

### CITATION LIST

### Patent Literature

PTL 1: JP 2014-077086 A
PTL 2: JP 2014-214268 A
PTL 3: JP 2012-073239 A

### Non-Patent Literature

NPL 1: Flue, 2014, Vol. 116, No. 15, p. 175-182
NPL 2: Energies, 2017, Vol. 10, No. 11, 1850
NPL 3: Tetsu-to-Hagane, 2015, Vol. 101, No. 8, p. 407-415
NPL 4: Journal of the Fuel Society of Japan, 1975, Vol. 54, Vol. 12, p. 983-993

### SUMMARY

### Technical Problem

As mentioned above, the use of biomass as a coke raw material can contribute to a decrease in CO₂ emissions from blast furnaces.

However, in the techniques proposed in PTL 1 and 2, in order to suppress a decrease in coke strength, the amount of biomass char added had to be 5 wt % or less of the total raw material. Further, NPL 2 reports that the use of lignin as a raw material creates voids and decreases coke strength.

Thus, the conventional techniques could not use a large amount of biomass as a coke raw material while maintaining coke strength.

It would be helpful to provide a method that can produce coke strong enough to withstand use in a blast furnace while using a larger amount of biomass as a coke raw material than in conventional techniques.

### Solution to Problem

As a result of intensive research, the inventors have discovered that the problems described above can be solved by using isolated lignin that satisfies specific conditions.

The present disclosure is based on the discoveries described above, and primary features of the present disclosure are as described below.

1. A method of producing metallurgical coke by dry distillation of raw material in a chamber-type coke oven to produce metallurgical coke, wherein
the raw material contains, at 30 wt % or less relative to the raw material total, one or both of isolated lignin and organic solvent extract from isolated lignin that have a permeation distance of 12 mm or more.

2. A method of producing metallurgical coke by dry distillation of raw material in a chamber-type coke oven to produce metallurgical coke, wherein
the raw material contains, at 30 wt % or less relative to the raw material total, one or both of isolated lignin and organic solvent extract from isolated lignin that have a weight-average molecular weight of 3100 or less.

3. A method of producing metallurgical coke by dry distillation of raw material to produce metallurgical coke, the method comprising:
measuring a permeation distance of one or both of isolated lignin and organic solvent extract from isolated lignin; and
using one or both of isolated lignin and organic solvent extract from isolated lignin for which the permeation distance measured is a predetermined reference value or greater, as a portion of the raw material.

4. A method of producing metallurgical coke by dry distillation of raw material to produce metallurgical coke, the method comprising:
measuring a weight-average molecular weight of one or both of isolated lignin and organic solvent extract from isolated lignin; and
using one or both of isolated lignin and organic solvent extract from isolated lignin for which the weight-average molecular weight measured is a predetermined reference value or less, as a portion of the raw material.

5. A method of evaluating thermoplasticity, the method comprising measuring a permeation distance of isolated lignin or organic solvent extract from isolated lignin to evaluate the thermoplasticity of the isolated lignin or organic solvent extract from isolated lignin.

### Advantageous Effect

According to the present disclosure, coke strong enough to withstand blast furnace use can be produced while using a larger amount of biomass as a coke raw material compared to conventional techniques. That is, as mentioned previously, conventional techniques require that the amount of biomass added be 5 wt % or less of the raw material total in order to prevent a decrease in coke strength. In contrast, according to the present disclosure, isolated lignin, a component derived from biomass, can be used in amounts up to 30 wt % of the raw material total. Further, according to the present disclosure, by using isolated lignin that satisfies specific conditions, contrary to conventional findings, coke can be produced that is strong enough to withstand blast furnace use, even when large amounts of isolated lignin are used.

### BRIEF DESCRIPTION OF THE DRAWINGS

In the accompanying drawings:

FIG. 1 is an image of a cross-section of coke obtained for Example No. 4, observed with a polarizing microscope; and

FIG. 2 is an image of a cross-section of coke obtained for Comparative Example No. 8, observed with a polarizing microscope.

### DETAILED DESCRIPTION

The following provides details of a method of carrying out the present disclosure. The following merely indicates preferred embodiments of the present disclosure, and the present disclosure is by no means limited to the disclosed embodiments.

### First Embodiment

First, a method of producing metallurgical coke according to a first embodiment of the present disclosure is described. In the method of producing metallurgical coke according to the present embodiment, metallurgical coke is produced by dry distillation of raw material in a chamber-type coke oven.

The chamber-type coke oven is not particularly limited, and any chamber-type coke oven having any structure may be used. The present disclosure allows the use of chamber-type coke ovens, which are used for typical conventional coke production without use of biomass raw material.

The dry distillation process is not particularly limited, and a typical dry distillation method using a chamber-type coke oven may be applied.

According to the present embodiment, one or both of isolated lignin and organic solvent extract from isolated lignin are used as a portion of the raw material. Hereinafter, both “isolated lignin” and “organic solvent extract from isolated lignin” may be referred to as “isolated lignin”

### Permeation Distance: 12 mm or More

According to the present embodiment, it is important that the permeation distance of the isolated lignin in the raw material is 12 mm or more. The reason for this is explained below.

The inventors investigated a relationship between the behavior of isolated lignin in raw material during dry distillation of the raw material to produce coke and the strength of the resulting coke. The results indicated that the behavior during heating varies greatly depending on the type of isolated lignin used. That is, most isolated lignin has poor thermoplasticity when heated, and therefore mixing isolated lignin in the raw material decreases the strength of the coke. On the other hand, some isolated lignin was found to have excellent thermoplasticity when heated, and instead acted to increase the strength of the coke.

After further investigation, the inventors found that the thermoplasticity of isolated lignin can be quantitatively evaluated based on permeation distance. When the permeation distance of the isolated lignin is less than 12 mm, the thermoplasticity of the isolated lignin is insufficient, resulting in insufficient coke strength. Therefore, according to the present embodiment, isolated lignin that has the permeation distance of 12 mm or more is used. From the viewpoint of further increasing coke strength, the permeation distance is preferably 13 mm or more. The permeation distance is more preferably 15 mm or more. On one hand, from the viewpoint of coke strength, the longer the permeation distance, the better, and therefore an upper limit of the permeation distance is not particularly limited. However, from the viewpoint of ease of obtaining and preparing isolated lignin, the permeation distance is preferably 40 mm or less.

The maximum fluidity (MF) measured by the Gieseler plastometer method specified in JIS M 8801 “Coal-testing methods” is used as an index to evaluate the thermoplasticity of coke raw material. However, the Gieseler plastometer method was designed to evaluate the properties of coal, and therefore cannot be used to evaluate the thermoplasticity of isolated lignin. For example, even when attempting to measure the maximum fluidity of isolated lignin alone using the Gieseler plastometer method, the properties of isolated lignin and coal are completely different, and therefore it is not possible to carry out measurement successfully in the first place. Further, when the maximum fluidity is measured with isolated lignin mixed with coal, then even when isolated lignin that has a long permeation distance is used, the value of the maximum fluidity is very low, like zero. From these measurements, it would normally be expected that coke in which isolated lignin is used as a raw material would have significantly lower strength, but actually the use of specific isolated lignin as raw material, as illustrated herein, improves coke strength over that of coal alone.

As noted above, the maximum fluidity, a commonly known index of thermoplasticity, does not adequately evaluate the effect of isolated lignin on thermoplasticity and coke strength. Therefore, the method of evaluating isolated lignin based on permeation distance and weight-average molecular weight proposed in the present disclosure is a novel method that is completely different from conventional methods, and is extremely effective in selecting isolated lignin for use as a coke raw material.

The permeation distance of isolated lignin according to the present embodiment is defined as the permeation distance measured by the following procedure.

First, the isolated lignin to be measured is passed through a sieve that has a mesh size of 2 mm to separate the lignin into oversieve and undersieve fractions. The isolated lignin remaining on the sieve is ground with a pestle and mortar, and the process is repeated until all of the isolated lignin passes through the sieve. Next, 1.0 g of the isolated lignin after the grinding and the passing through the sieve is filled into a quartz container that has an inner diameter of 20 mm and a height of 100 mm. A 200 g weight is then dropped five times from 20 mm above the isolated lignin. Further, glass beads (diameter: 2.0 mm, material: soda glass, specific gravity: 2.5) are filled on top of the isolated lignin to a layer thickness of 50 mm to 55 mm. The weight of the glass beads filled at this time is G (g).

A quartz filter (diameter: 19 mm×thickness: 5 mm) and a weight (1.6 kg) are placed on top of the layer of glass beads in this order.

The quartz container into which the isolated lignin is filled is then heated from room temperature to 550° C. at 3° C./min in an electric furnace under a nitrogen atmosphere. The heated isolated lignin melts, expands, and permeates into the layer of the glass beads, then re-solidifies and adheres to a portion of the glass beads. After natural cooling in a nitrogen atmosphere, the glass beads that have not adhered to the isolated lignin are removed from the quartz container, and the weight of the glass beads, M (g), is measured.

From the measured weight of the glass beads, the permeation distance D (mm) is calculated using Expression (1) below.

$$Permeation distance D ( mm ) = H \times ( G - M ) \qquad ( 1 )$$

Here,
H: filling height per unit of glass bead weight in quartz container (mm/g)
G: weight of filled glass beads (g)
M: weight of glass beads that did not adhere to isolated lignin (g)

The method of measuring permeation distance was determined with reference to the methods described in PTL 3 and NPL 3. However, in PTL 3 and NPL 3, the methods are only used to evaluate the thermoplasticity of coal and caking additives, and application to isolated lignin was not described.

A method of preparing isolated lignin that satisfies the conditions described above is described below.

### Mix Proportion: 30 wt % or Less

Isolated lignin that satisfies the conditions described above has superior thermoplasticity, and can therefore be added to raw material in larger quantities than in conventional techniques. However, when the mix proportion exceeds 30 wt % of the raw material total, the coke strength will decrease. Therefore, the mix proportion of the isolated lignin to the raw material total is 30 wt % or less. On the other hand, a lower limit of the mix proportion is not particularly limited. From the viewpoint of decreasing CO₂ emission, the mix proportion preferably exceeds 2 wt %. The mix proportion more preferably exceeds 5 wt %. The mix proportion is even more preferably 6 wt % or more. The mix proportion is most preferably 10 wt % or more.

When both isolated lignin and organic solvent extract from isolated lignin are used as raw material, the total mix proportion of isolated lignin and organic solvent extract from isolated lignin in the raw material is 30 wt % or less.

The size of the isolated lignin is not particularly limited, and any size of isolated lignin may be used. Typically, the particle size of isolated lignin is finer than the particle size of coal used in coke production and may be used as is without undergoing a process such as grinding. However, from the viewpoint of increasing uniform dispersibility of isolated lignin in raw material and decreasing variation in coke strength, it is also desirable to pre-grind the isolated lignin to increase the proportion of fine particles.

Specifically, preferably, the proportion of isolated lignin particles having a particle size of 3 mm or less is 80 wt % or more. More preferably, the proportion of isolated lignin particles having a particle size of 2 mm or less is 80 wt % or more. The proportion of particles having a particle size of 3 mm or less being 80 wt % or more means that when the isolated lignin is passed through a sieve that has a mesh size of 3 mm and is separated into oversieve and undersieve fractions, the undersieve weight fraction is 80 wt % or more of the isolated lignin total. Further, the proportion of particles having a particle size of 2 mm or less being 80 wt % or more means that when the isolated lignin is passed through a sieve that has a mesh size of 2 mm and is separated into oversieve and undersieve fractions, the undersieve weight fraction is 80 wt % or more of the isolated lignin total.

On the other hand, the higher the proportion of the fine particles, the better, and therefore an upper limit is not particularly limited. Therefore, the proportion of isolated lignin particles having a particle size of 3 mm or less is 100 wt % or less. Similarly, the proportion of isolated lignin particles having a particle size of 2 mm or less is 100 wt % or less.

There are no particular limitations on raw material other than the isolated lignin, and any raw material may be used. Typically, as raw material other than the isolated lignin, coal can be used. As the coal, any coal may be used without any particular limitation. The coal that can be used includes raw material coal typically used in coke production, as well as non-caking or poorly caking anthracite, semi-anthracite, bituminous coal, sub-bituminous coal, lignite coal, and the like. The raw material may be one or more of coke breeze, oil coke, plastic, biomass other than isolated lignin, carbide obtained by heat treatment of biomass other than isolated lignin, and the like. Such raw material may be mixed with coal. However, biomass (that isn't heat-treated) other than plastic and isolated lignin contains high volatile content, and therefore excessive inclusion results in a decrease in quality, such as an increase in pores in the coke. Therefore, the total mix proportion of plastic and biomass other than isolated lignin to the total raw material is preferably 10 wt % or less. The total mix proportion is more preferably 5 wt % or less. A lower limit of the total mix proportion of plastic and biomass other than isolated lignin may be 0%.

Further, binder may be added as a portion of the raw material to further increase coke strength. As the binder, for example, one or more of coal tar pitch, tar, tar sludge, asphalt pitch, solvent-refined coal, and the like may be used.

### Second Embodiment

Next, a method of producing metallurgical coke according to a second embodiment of the present disclosure is described. Matters not specifically mentioned may be the same as for the first embodiment above.

### Weight-Average Molecular Weight: 3100 or Less

According to the present embodiment, it is important that the weight-average molecular weight of the isolated lignin in the raw material is 3100 or less. The reason for this is explained below.

As mentioned above, the inventors found that the thermoplasticity of isolated lignin can be quantitatively evaluated based on the permeation distance. Subsequent further investigation revealed that the thermoplasticity of isolated lignin also correlates with the weight-average molecular weight of isolated lignin. Specifically, the smaller the weight-average molecular weight of the isolated lignin, the better the thermoplasticity and therefore the higher the strength of the coke.

Conversely, when the weight-average molecular weight is greater than 3100, the thermoplasticity of the isolated lignin is insufficient, and as a result, sufficient coke strength cannot be obtained. For this reason, according to the present embodiment, isolated lignin that has a weight-average molecular weight of 3100 or less is used. From the viewpoint of further increasing coke strength, the weight-average molecular weight is preferably 3000 or less. The weight-average molecular weight is more preferably 2900 or less. The weight-average molecular weight is even more preferably 2700 or less. On the other hand, from the viewpoint of coke strength, the lower the weight-average molecular weight, the better, and therefore a lower limit of the weight-average molecular weight is not particularly limited. However, from the viewpoint of ease of obtaining and preparing isolated lignin, the weight-average molecular weight is preferably 1500 or more.

The weight-average molecular weight of isolated lignin according to the present disclosure is a value measured by gel permeation chromatography (GPC). More specifically, measurements may be made by a method described in the EXAMPLES section of the present disclosure.

A method of preparing isolated lignin that satisfies the conditions described above is described below.

Also according to the present embodiment, the mix proportion of the isolated lignin to the raw material total is 30 wt % or less. The reasons for this are as explained for the first embodiment. Further, the preferred mix proportion of the isolated lignin is also the same as for the first embodiment.

The isolated lignin may further have a permeation distance of 12 mm or more. In other words, according to another embodiment of the present disclosure, one or both of isolated lignin and organic solvent extract from isolated lignin that have a weight-average molecular weight of 3100 or less and a permeation distance of 12 mm or more can be used.

### Third Embodiment

Next, a method of producing metallurgical coke according to a third embodiment of the present disclosure is described. Matters not specifically mentioned may be the same as for the first embodiment above.

According to the present embodiment, metallurgical coke is produced by dry distillation of raw material. In doing so, the permeation distance of one or both of isolated lignin and organic solvent extract from isolated lignin is measured, and one or both of isolated lignin and organic solvent extract from isolated lignin for which the permeation distance measured is a predetermined reference value or greater is used as a portion of the raw material.

As mentioned above, the thermoplasticity of isolated lignin can be quantitatively evaluated based on the permeation distance. Therefore, the strength of coke can be improved by measuring the permeation distance of isolated lignin and selecting and using isolated lignin that has a permeation distance that is the predetermined reference value or greater.

As described above, the present embodiment is characterized by the measuring of the permeation distance of the isolated lignin and the selecting of the isolated lignin to be used based on the measurement results. Therefore, the reference value used to select the isolated lignin is not particularly limited and may be any value. The reference value is predetermined according to required coke strength. For example, the reference value may be 12 mm, 13 mm or more, or 15 mm or more. An upper limit of the permeation distance is not particularly limited. However, from the viewpoint of ease of obtaining and preparing isolated lignin, it is preferable to use of one or both of isolated lignin and organic solvent extract from isolated lignin that has a permeation distance of 40 mm or less.

Similarly, according to the present embodiment, the mix proportion of isolated lignin to the raw material total is not particularly limited. The mix proportion is preferably 30 wt % or less. A lower limit of the mix proportion is also not particularly limited. From the viewpoint of decreasing CO₂ emission, the mix proportion preferably exceeds 2 wt %. The mix proportion more preferably exceeds 5 wt %. The mix proportion is even more preferably 6 wt % or more. The mix proportion is most preferably 10 wt % or more.

### Fourth Embodiment

Next, a method of producing metallurgical coke according to a fourth embodiment of the present disclosure is described. Matters not specifically mentioned may be the same as in the second embodiment above.

According to the present embodiment, as for the second embodiment above, metallurgical coke is produced by dry distillation of raw material. In doing so, the weight-average molecular weight of one or both of isolated lignin and organic solvent extract from isolated lignin is measured, and one or both of isolated lignin and organic solvent extract from isolated lignin for which the weight-average molecular weight measured is a predetermined reference value or less is used as a portion of the raw material.

As mentioned above, there is a correlation between the thermoplasticity and weight-average molecular weight of isolated lignin. Therefore, the strength of coke can be improved by measuring the weight-average molecular weight of isolated lignin and selecting and using isolated lignin that has a weight-average molecular weight that is the predetermined reference value or less.

As described above, the present embodiment is characterized by the measuring of the weight-average molecular weight of the isolated lignin and the selecting of the isolated lignin to be used based on the measurement results. Therefore, the reference value used to select the isolated lignin is not particularly limited and may be any value. The reference value is predetermined according to required coke strength. For example, the reference value may be 3100 or less, 3000 or less, or 2900 or less. On the other hand, a lower limit of the weight-average molecular weight is not particularly limited. The weight-average molecular weight is preferably 1500 or more.

Similarly, according to the present embodiment, the mix proportion of isolated lignin to the raw material total is not particularly limited. The mix proportion is preferably 30 wt % or less. A lower limit of the mix proportion is also not particularly limited. From the viewpoint of decreasing CO₂ emission, the mix proportion preferably exceeds 2 wt %. The mix proportion more preferably exceeds 5 wt %. The mix proportion is even more preferably 6 wt % or more. The mix proportion is most preferably 10 wt % or more.

### Fifth Embodiment

The fifth embodiment of the present disclosure relates to a method of evaluating thermoplasticity of isolated lignin or organic solvent extract from isolated lignin. The evaluation method according to the present embodiment measures the permeation distance of the isolated lignin or organic solvent extract from isolated lignin to evaluate the thermoplasticity of the isolated lignin or organic solvent extract from isolated lignin.

According to the third embodiment and the fifth embodiment, the method of measuring the permeation distance is not particularly limited, but the following procedure is preferred.

First, the isolated lignin to be measured is ground. The ground isolated lignin is preferably sieved as required to adjust the particle size to a certain particle size or less. The ground isolated lignin is then filled into a measurement container. Any measurement container can be used, but a cylindrical container is preferred. When a cylindrical container is used, the inner diameter of the container is preferably 10 mm or more. Further, the inner diameter is preferably 50 mm or less. The material of the container is not particularly limited, but the container is preferably made of quartz.

Next, pressure is applied from above to the isolated lignin filled in the measurement container. The method of applying pressure is not particularly limited, but pressure is applied under the same conditions for each measurement to secure reproducibility of the measurement. For example, a weight may be dropped from above the isolated lignin filled in the measurement container to apply pressure.

Next, a plurality of glass beads are filled on top of the filled isolated lignin to form a glass bead layer that has a defined thickness. The plurality of glass beads are of the same size and material as each other. The preferred diameter is 1.0 mm or more. The preferred diameter is 3.0 mm or less. The thickness of the glass bead layer is not particularly limited. The thickness is preferably 40 mm or more. The thickness is preferably 70 mm or less.

Further, a weight is placed on top of the glass bead layer to apply load to the isolated lignin. Depending on the inner diameter of the container, the weight preferably results in a load of 5 kPa or more. The weight preferably results in a load of 80 kPa or less. A plate-like member is preferably disposed between the glass bead layer and the weight. By placing the weight via the plate-like member, the load is transmitted more uniformly to the glass beads, improving measurement precision. The plate-like member is preferably made of quartz. From the viewpoint of facilitating the release of gas generated during heating, the plate-like member is preferably porous. For example, a quartz filter can be used as a porous plate-like member. When the plate-like member is not porous, a gap is preferably provided between the inner wall of the measurement container and the plate-like member to facilitate gas release.

The measurement container filled with the isolated lignin is then heated to a defined temperature. The heated isolated lignin melts, expands, and permeates into the layer of the glass beads, then re-solidifies and adheres to a portion of the glass beads. The heating is preferably carried out in an inert atmosphere, and more preferably in a nitrogen atmosphere. The heating temperature is not particularly limited, as long as it is 500° C. or more. For appropriate evaluation of thermoplasticity of isolated lignin, the heating temperature is preferably from 500° C. to 600° C.

After cooling, the glass beads that have not adhered to the isolated lignin are removed from the quartz container, and the weight of the glass beads, M(g), is measured. From the measured weight of the glass beads, the permeation distance D (mm) is calculated using Expression (1) below.

$$Permeation distance D ( mm ) = H \times ( G - M ) \qquad ( 1 )$$

Here,
H: filling height per unit of glass bead weight in quartz container (mm/g)
G: weight of filled glass beads (g)
M: weight of glass beads that did not adhere to isolated lignin (g)

The permeation distance measurement is preferably carried out by the method described for the first embodiment.

### (Method of Preparing Isolated Lignin)

Next, the method of preparing isolated lignin is described. According to the present disclosure, isolated lignin obtained by any method may be used, without particular limitation. For example, isolated lignin precipitated from black liquor, a by-product of a cooking process in the chemical pulping method, can be used. Precipitation of isolated lignin from the black liquor can be carried out, for example, by adding an acid such as carbonic acid or sulfuric acid to the black liquor.

Any wood raw material may be used to produce isolated lignin without any particular limitation. Both hardwood and softwood may be used as the wood raw material.

For example, isolated lignin obtained by kraft cooking of wood (kraft lignin) may be used as the isolated lignin. The conditions for kraft cooking are not particularly limited. The sulfide content of the kraft cooking solution is preferably 5% or more. The sulfide content is preferably 75% or less. The sulfide content is more preferably 15% or more. The sulfide content is more preferably 45% or less. Per dry wood weight, the effective alkali addition rate is preferably 5 wt % or more. The effective alkali addition rate is preferably 30 wt % or less. The effective alkali addition rate is more preferably 10 wt % or more. The effective alkali addition rate is more preferably 25 wt % or less. The cooking temperature is preferably 130° C. or more. The cooking temperature is preferably 170° C. or less. The cooking method may be either continuous cooking or batch cooking. When a continuous cooking digester is used, a modified cooking method in which the cooking solution is added at multiple points may be used, regardless of the method used.

A cooking agent is preferably used in the cooking process. As the cooking agent, preferably one or more selected from known cyclic keto compounds, such as benzoquinone, naphthoquinone, anthraquinone, anthrone, phenanthroquinone, and the above quinone compounds substituted with an alkyl group, aldehyde group, amino group, fluorine group, or the like, or Hydroquinone compounds such as anthrahydroquinone, which are reduced forms of the above quinone compounds, and 9,10-diketohydroanthracene compounds, which are stable compounds obtained as intermediates in the synthesis of anthraquinone by the Diels-Alder method. The rate of addition of the cooking agent is preferably 0.001 wt % or more. The rate of addition is preferably 1.0 wt % or less.

When the weight-average molecular weight or the permeation distance of the isolated lignin obtained does not satisfy the criteria, a portion of the isolated lignin may be extracted by an organic solvent. When the organic solvent extract obtained satisfies the above criteria, the organic solvent extract may be used as a coke raw material. Any organic solvent may be used as the organic solvent. Acetone is preferred as the organic solvent.

The method of extraction is not particularly limited, but for example, by stirring the isolated lignin in an organic solvent, a portion of the isolated lignin can be extracted into the organic solvent. The organic solvent extract of isolated lignin is then obtained by volatilizing the organic solvent. When the molecular weight or the permeation distance of the resulting organic solvent extract satisfies the criteria, the organic solvent extract may be used as a coke raw material.

### Examples

The following tests were carried out to confirm the effectiveness of the present disclosure.

### Example Group 1

Ten types of isolated lignin that had different permeation distances and weight-average molecular weights were used as portions of raw material to produce coke. The ten types of isolated lignin used are listed in Table 1. No. 1 to No. 8 were isolated lignin, and No. 9 was an extract obtained by extracting a portion of the isolated lignin of No. 6 by acetone. On the other hand, No. 10 is the residue from the extraction.

The permeation distance and the weight-average molecular weight of each isolated lignin were respectively determined by the following methods. The measurement results are listed in Table 1.

### (Permeation Distance)

The permeation distance of the isolated lignin was measured by the method described for the first embodiment.

### (Weight-Average Molecular Weight)

The weight-average molecular weight of the isolated lignin was measured by gel permeation chromatography (GPC). The measurement conditions are listed below.
Analyzer: high performance liquid chromatograph LcSolution Multi-PDA (Shimadzu Corporation)
Column: HM-55F custom column (Tosoh Corporation)
Separation solution: 0.5 mol/L NaOH
Flow rate: 1.0 mL/min
Detector: UV detector (280 nm)

The isolated lignin was used as a portion of the raw material to produce coke according to the following procedure. The following tests were carried out under conditions simulating dry distillation conditions in a chamber-type coke oven.

First, the isolated lignin listed in Table 1 and coal were each ground so that 100% passed through a 0.5 mm sieve. Ground isolated lignin and coal were mixed in the ratio of coal: 80 wt % and isolated lignin: 20 wt %, and molded into cylinders. The molding was carried out by loading a 1.0 g (dry basis) mixture of coal and isolated lignin into a 12 mm diameter mold and then applying a compaction force of 2 tonne-force. Further, Coal A (see Table 2), which has maximum fluidity MF: 29 ddpm and reflectance Ro: 1.23%, was used as the coal.

The resulting molding was heated to 1000° C. at a heating rate of 3° C./min in an N₂ flow to produce coke. The strength of the resulting cylindrical coke was then measured. As the coke strength, the indirect tensile strength described in NPL 4 was measured. The measurement results are listed in Table 1.

For comparison, the results of coke production using only Coal A without the addition of isolated lignin are also listed in Table 1 as No. 11.

The coke strength of No. 11, where coke was produced using only Coal A without the addition of isolated lignin, was 3.5 MPa. The indirect tensile strength of cylindrical coke, which is hollowed out from typical coke into a cylindrical shape, averages about 5 MPa, although there is a wide variation.

As can be seen from the results listed in Table 1, the coke strength was significantly higher for the Examples where isolated lignin satisfying the conditions of the present disclosure was used, compared to the case where isolated lignin was not used (No. 11). In contrast, for the Comparative Examples where isolated lignin that did not satisfy the conditions of the present disclosure was used, the coke strength was either the same or inferior to that of the case where isolated lignin was not used (No. 11).

TABLE 1

| | | | | | Evaluation | |
|---|---|---|---|---|---|---|
| | Isolated lignin | | | | result | |
| | | | Average | Permeation | Coke | |
| | | Pulping | molecular | distance | strength | |
| No. | Type | process | weight | (mm) | (MPa) | Remarks |
| 1 | Hardwood lignin | Kraft | 2400 | 26.8 | 13.8 | Example |
| 2 | Hardwood lignin | Kraft | 2600 | 12.4 | 9.5 | Example |
| 3 | Hardwood lignin | Soda | 5230 | 10.0 | 1.7 | Comparative Example |
| 4 | Hardwood lignin | Soda | 2690 | 23.3 | 11.5 | Example |
| 5 | Softwood lignin | Kraft | 3460 | 0 | 2.1 | Comparative Example |
| 6 | Softwood lignin | Kraft | 3510 | 10.3 | 4.0 | Comparative Example |
| 7 | Softwood lignin | Kraft | 3210 | 7.3 | 4.7 | Comparative Example |
| 8 | Softwood lignin | Soda | 4620 | 0.9 | 2.2 | Comparative Example |
| 9 | No. 6-acetone extract | — | 2980 | 17.4 | 11.7 | Example |
| 10 | No.6-acetone extract residue | — | 5420 | 0 | 0.5 | Comparative Example |
| 11 | — | — | — | — | 3.5 | Comparative Example |

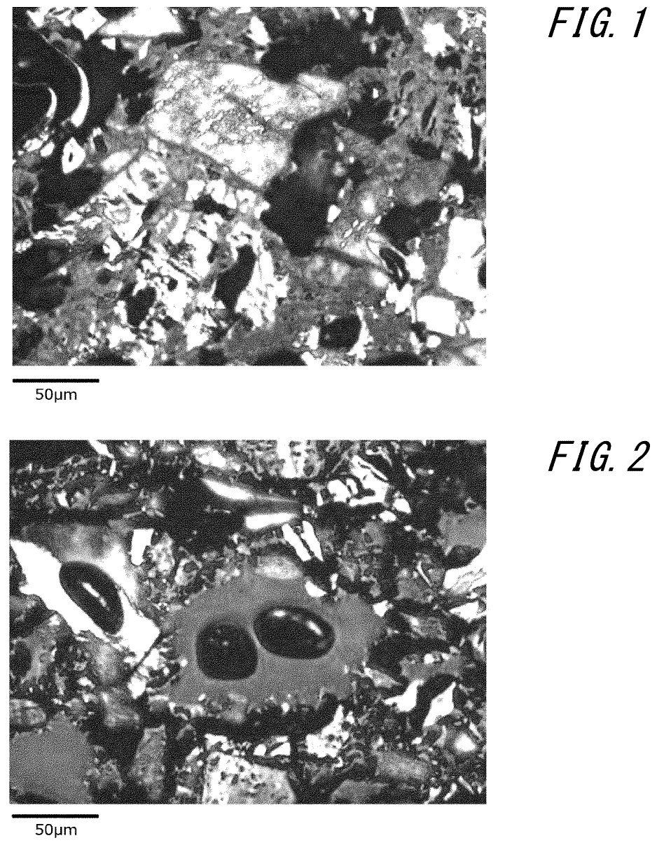

Images of cross-sections of the coke obtained for Example No. 4 and Comparative Example No. 8 observed with a polarizing microscope are illustrated in FIG. 1 and FIG. 2. In FIG. 1 and FIG. 2, the white areas are coal, the gray areas are isolated lignin, and the black areas are voids. As illustrated in FIG. 1, in the coke of Example No. 4, isolated lignin flowed between coal particles to form bonds. In contrast, in the coke of Comparative Example No. 8, the coal particles and isolated lignin are surrounded by voids as illustrated in FIG. 2, indicating that they are not bound together. This difference in internal structure of the coke is thought to have caused the difference in the coke strength. And this difference in structure can be attributed to the different thermoplasticity of the isolated lignin used, as mentioned earlier.

### Example Group 2

Next, coke was produced by combining various carbon materials with isolated lignin. Specifically, the raw material was a mixture of the carbon material listed in Table 2 and the isolated lignin used for Example No. 1 in Example Group 1. The mix proportions of the carbon material and the isolated lignin are listed in Table 2.

The carbon material and isolated lignin were molded into cylinders using the same procedure as for Example Group 1. The cylindrically molded raw material was then dry distilled to obtain cylindrical coke under the same conditions as for Example Group 1. The coke strength (indirect tensile strength) of the resulting cylindrical coke was measured in the same manner as for Example Group 1. The measurement results are listed in Table 2.

As indicated in Table 2, the coke strength was significantly improved for the Examples where isolated lignin was added that satisfied the conditions of the present disclosure, regardless of the type of carbon material used. In particular, coke that had a strength comparable to that of typical coke (5 MPa) could be produced by adding isolated lignin that satisfied the conditions of the present disclosure, even when using carbon material such as biomass char that indicates no melting properties at all. This may be due to the isolated lignin softening and melting to form bonds between the biomass char particles. In contrast, for the Comparative Examples where only biomass char was used as raw material without the addition of isolated lignin, the material did not agglomerate after dry distillation and coke strength could not be measured.

TABLE 2

| Carbon material | | | | | | Evaluation | |
|---|---|---|---|---|---|---|---|
| | | Maximum | Volatile | Mix proportion | | result | |
| | Reflectance | fluidity | portion | Carbon | Isolated | Coke | |
| | Ro | MF | (wt %, | material | lignin | strength | |
| Type | (%) | (ddpm) | d.b.) | (wt %) | (wt %) | (MPa) | Remarks |
| Coal A | 1.23 | 29 | 22 | 100 | 0 | 2.5 | Comparative Example |
| | | | | 94 | 6 | 5.1 | Example |
| | | | | 90 | 10 | 6.8 | Example |
| | | | | 80 | 20 | 12.0 | Example |
| Coal B | 0.98 | 335 | 28 | 100 | 0 | 4.3 | Comparative Example |
| | | | | 98 | 2 | 6.3 | Example |
| | | | | 94 | 6 | 9.3 | Example |
| | | | | 90 | 10 | 11.0 | Example |
| | | | | 80 | 20 | 18.3 | Example |
| Coal C | 0.79 | 3187 | 36 | 100 | 0 | 2.7 | Comparative Example |
| | | | | 90 | 10 | 7.2 | Example |
| | | | | 80 | 20 | 15.5 | Example |
| Coal D | 1.19 | 0 | 20 | 100 | 0 | 1.1 | Comparative Example |
| | | | | 80 | 20 | 12.2 | Example |
| Biomass char | — | — | 18 | 100 | 0 | No | Comparative Example |
| | | | | | | agglomeration | |
| | | | | 70 | 30 | 5.4 | Example |

### (Example Group 3)

Next, the mix proportion of the isolated lignin was varied to produce coke. Specifically, as raw material, Coal A indicated in Table 2 was mixed with the isolated lignin used in Example No. 1 and Comparative Example No. 6 from Example Group 1. The mix proportions of the carbon material and the isolated lignin are listed in Table 3.

Coal A and the isolated lignin were molded into cylinders using the same procedure as for Example Group 1. The cylindrically molded raw material was then dry distilled to obtain cylindrical coke under the same conditions as for Example Group 1. The coke strength (indirect tensile strength) of the resulting cylindrical coke was measured in the same manner as for Example Group 1. The measurement results are listed in Table 3.

As indicated in Table 3, for the Examples where isolated lignin No. 1 was added that satisfied the conditions of the present disclosure, the coke strength was improved under conditions where the mix proportion of the isolated lignin was 30 wt % or less. However, for the Comparative Examples where the mix proportion of the isolated lignin exceeded 30 wt %, strength could not be measured because the sample was deformed during dry distillation and was no longer cylindrical in shape. On the other hand, for the Comparative

Examples using the isolated lignin No. 6 that did not satisfy the conditions of the present disclosure, no significant improvement in the coke strength was observed regardless of the mix proportion.

TABLE 3

| | | Mix proportion | | Evaluation result | | |
|---|---|---|---|---|---|---|
| | | Carbon | Isolated | Coke | Drum strength | |
| Carbon | Isolated | material | lignin | strength | index | |
| material | lignin | (wt %) | (wt %) | (MPa) | DI 150/15 | Remarks |
| Coal A | — | 100 | 0 | 3.1 | 78.2 | Comparative Example |
| | No. 1 | 80 | 20 | 13.9 | 79.5 | Example |
| | | 70 | 30 | 15.1 | 80.5 | Example |
| | | 60 | 40 | Deformation | 79.1 | Comparative Example |
| | No. 6 | 80 | 20 | 4.0 | 76.4 | Comparative Example |
| | | 70 | 30 | 3.3 | 53.2 | Comparative Example |
| | | 60 | 40 | 2.6 | 60.3 | Comparative Example |

### Example Group 4

Further, the same combinations of coal and isolated lignin as in Example Group 3 were used as raw material for a large-scale test. Specifically, Coal A and isolated lignin (No. 1 or No. 6) were ground so that 100% passed through a 3 mm sieve. After the grinding, Coal A and isolated lignin were mixed in the different proportions listed in Table 3, and the resulting mixture of 15 kg (dry basis) was filled into a stainless steel container to a density of 750 kg/m³ (dry basis). Coke was then produced by dry distillation at 1050° C. for 6 hours.

To evaluate the strength of coke obtained by the above procedure, the drum test specified in JIS K2151: 2004 was carried out under the conditions of 150 revolutions and a particle size of 15 mm or more. Drum strength index (DI 150/15) was measured. The measurement results are listed in Table 3.

In this Example Group, as in Example Group 3, the drum strength index was improved for Examples with the addition of isolated lignin No. 1 that satisfied the conditions of the present disclosure, under conditions where the mix proportion of the isolated lignin was 30 wt % or less. However, when the mix proportion of the isolated lignin exceeded 30 wt %, the drum strength index decreased. This may be due to the higher volatile content in isolated lignin compared to coal. That is, when the mix proportion of isolated lignin exceeds 30 wt %, the strength loss due to volatile content exceeds the strength improving effect of the isolated lignin.

1. A method of producing metallurgical coke by dry distillation of raw material in a chamber-type coke oven to produce metallurgical coke, wherein
the raw material contains, at 30 wt % or less relative to the raw material total, one or both of isolated lignin and organic solvent extract from isolated lignin that have a permeation distance of 12 mm or more.

2. A method of producing metallurgical coke by dry distillation of raw material in a chamber-type coke oven to produce metallurgical coke, wherein
the raw material contains, at 30 wt % or less relative to the raw material total, one or both of isolated lignin and organic solvent extract from isolated lignin that have a weight-average molecular weight of 3100 or less.

3. A method of producing metallurgical coke by dry distillation of raw material to produce metallurgical coke, the method comprising:
measuring a permeation distance of one or both of isolated lignin and organic solvent extract from isolated lignin; and
using one or both of isolated lignin and organic solvent extract from isolated lignin for which the permeation distance measured is a predetermined reference value or greater, as a portion of the raw material.

4. A method of producing metallurgical coke by dry distillation of raw material to produce metallurgical coke, the method comprising:
measuring a weight-average molecular weight of one or both of isolated lignin and organic solvent extract from isolated lignin; and
using one or both of isolated lignin and organic solvent extract from isolated lignin for which the weight-average molecular weight measured is a predetermined reference value or less, as a portion of the raw material.

5. A method of evaluating thermoplasticity, the method comprising measuring a permeation distance of isolated lignin or organic solvent extract from isolated lignin to evaluate the thermoplasticity of the isolated lignin or organic solvent extract from isolated lignin.
